(19) United States
(12) Patent Application Publication
(10) Pub. No.: US 2014/0042084 A1
(43) Pub. Date: Feb. 13, 2014

(54) METHOD AND APPARATUS FOR CLEANING A FILTRATION CASSETTE OF A MEMBRANE BIO-REACTOR

(71) Applicants: Jeff Kempson, Brockville (CA); Ulrich Weise, Langgons (DE); Stanislaus Pawlinski, Friedberg (DE)

(72) Inventors: Jeff Kempson, Brockville (CA); Ulrich Weise, Langgons (DE); Stanislaus Pawlinski, Friedberg (DE)

(21) Appl. No.: 13/570,385

(22) Filed: Aug. 9, 2012

(51) Int. Cl. B01D 65/02; C02F 9/14

(52) U.S. Cl. 210/601; 210/151

(57) ABSTRACT

A method and apparatus for cleaning a membrane bioreactor having a stack of generally vertically oriented membrane filter plates mounted in a filtration chamber containing wastewater. In a first cleaning phase, air is supplied to a first discharge zone under the stack to discharge gas bubbles into the wastewater at the bottom of the stack so that the gas bubbles rise upwardly through passages between the filter plates to scour surfaces of the membranes bounding the passages. In a second cleaning phase, gas is supplied to a second discharge zone at the bottom of the stack and surrounding it to cause air lift induced circulation of the wastewater up around the sides of the stack and downwardly through the passages between the filter plates to eject accumulated fibrous material from the passages and to scour surfaces of the membranes bounding the passages.

### FIELD OF THE INVENTION

This invention relates to a method and apparatus for cleaning a filtration cassette forming part of a membrane bio-reactor such as a suspended filtration cassette bio-reactor for treating wastewater.

### DISCUSSION OF RELATED ART

A membrane bioreactor (MBR) combines a membrane filtration process with a bioreaction process. The bioreaction process occurs within wastewater liquor contained within a chamber and the filtration process occurs at a membrane filtration cassette. In a suspended filtration cassette MBR, the filtration cassette is suspended in the bioreaction chamber, while in an external or sidestream MBR, the bioreaction process and the filtration process take place in separate chambers with the output from the bioreaction process being piped from the bioreaction chamber to the filtration chamber.

MBRs are widely used for municipal and industrial wastewater treatment. They may be large scale sewage installations having a typical capacity of 30 million gallons per day, municipal installations having a typical capacity of 150,000 gallons per day, or, for example, domestic units designed to be compact and economic and to have low management and servicing demands. Grey-water and wastewater treated using a high quality MBR can be used for toilet flushing, landscape irrigation/watering, vehicle washing/bathing and as general service water. MBR processing effectively neutralizes odour and substantially eliminates staining of ceramic and other surfaces. In this specification, the term “wastewater” means any water that has been adversely affected in quality by anthropogenic influence. It comprises liquid waste discharged from dwellings and commercial, industrial and agricultural sites and encompasses a range of contaminants and concentrations. It particularly includes municipal wastewater resulting from mixing wastewater from dwellings, businesses, industrial areas and storm drains.

A known form of suspended filtration MBR has a filtration cassette consisting of a stacked series of filter packs mounted in a frame which is suspended in the bioreaction chamber. Each filter pack is configured as a generally vertically oriented plate with the stack extending horizontally. Each plate has a pair of flat ultrafine pore size membranes which flank and are welded to an intervening grid. The grid defines a series of receiving chambers which are connected to an outlet manifold. In use, a negative pressure is applied at the outlet manifold to stimulate the passage of wastewater from outside the filtration filter plates, across the membranes, into the receiving chambers and then to the outlet manifold. In the course of the passage of water though the membranes, particulate, bacterial and viral content in the wastewater is filtered out. An MBR using this type of membrane stack is available from Weise Water Systems GmbH under the trademark MICROCLEAR™. Other forms of suspended MBR use membrane packs of different form: for example, tubular.

A significant problem with MBR processes and equipment is filtration cassette blockage. Blockages may arise for a number of reasons. One source of blockage is fibrous material, such as hair, that is not properly removed by pre-filtering the wastewater at screens through which the wastewater is directed before it is piped into the membrane filtration chamber. Fibrous material that is not separated at the screens may accumulate within entry ways of passages of the filtration cassette through which the wastewater is directed past the membranes. The accumulating fibres eventually form a mat which then collects grease which can lead to one or more of the passages becoming plugged.

In another blocking mechanism, areas of the membranes themselves become blocked. In one effect, bio-fouling accumulates as a compressible coating on the membrane or in the membrane pores and is caused by deposition and/or absorption of organic and/or colloidal substances. The use of ultra-filtration membranes having pores that are much smaller than most micro-organisms limits, but does not prevent, such membrane fouling. In a further blocking mechanism, inorganic matter precipitates onto the membranes as scaling. Scaling is primarily caused by hardness agents such as calcium and magnesium.

While filtration cassette blockage and membrane fouling can be corrected by frequent chemical cleaning, this presents problems including additional cost, downtime of the filtration cassette, and formation of hazardous byproducts. Other methods have been used during normal operation to inhibit membrane fouling and so extend the operational periods between chemical cleaning. One known method is air scouring or sparging. To this end, in the aforementioned Weise Water Systems MicroClear cassette, each of the filtration filter plates extends vertically with the filter plates forming a horizontally extending stack. As shown in FIG. 1, the filter plates are mounted in rectangular frames which are shaped to define a circulation space between a membrane of one filter plate and the facing membrane of the next adjacent filter plate. It is into this space that the wastewater flows and from which it is drawn through the membranes into the filter plates by the negative pressure applied at the outlet manifold.

For continuous cleaning, tiny air bubbles are released at the bottom of the stack and rise up through the spaces between the membranes of adjacent filter plates. This causes an air lift of the water located between the membrane filter plates with the airlifted water rising up and circulating down around the outside of the filtration cassette. The airlifted water current, the turbulence caused by the rising bubbles, and the impact of bubble boundaries against a membrane surface, all serve to discourage particulate and biofilm forming matter from lodging at the membrane surface. Shear forces produced by the air bubbles can be increased by periodically removing the manifold negative pressure to produce filtration pauses. Aeration cleaning is reinforced during such pauses since particles on the membrane's surface are no longer encouraged to stay place by the normal suction pressure present during filtration.

While air scouring offers an effective and valuable method of preventing fouling of the filtration cassette membranes, improvements are possible in the continuous cleaning method and apparatus to extend the operational periods possible between chemical cleanings of the filtration cassette membranes.

### SUMMARY OF THE INVENTION

According to one aspect of the invention, there is provided a method of cleaning a MBR filtration cassette having a stack of generally vertically oriented membrane filter packs mounted in a chamber containing wastewater comprising, in a first cleaning phase, supplying air to a first discharge zone to discharge gas bubbles into the wastewater at the bottom of the stack, whereby the gas bubbles rise in a first direction through passages between the filter packs to scour surfaces of the membranes bounding the passages, and, in a second cleaning phase, supplying gas to a second discharge zone to cause circulation of the wastewater over said surfaces of the membranes bounding the passages in a direction different from the first direction.

A method of cleaning a MBR filtration cassette having a stack of generally vertically oriented membrane filter packs mounted in a filtration chamber containing wastewater comprising, in a first cleaning phase, supplying air to a first discharge zone to discharge gas bubbles into the wastewater at the bottom of the stack, whereby the gas bubbles rise in a first direction through passages between the filter packs to scour surfaces of the membranes bounding the passages, and, in a second cleaning phase, supplying gas to a second discharge zone to cause circulation of the wastewater up around the outside of the filtration cassette and down through the passages in a direction different from the first direction.

Preferably, the first discharge zone is located under the filtration cassette, whereby the bubbles in said first cleaning phase rise upwardly past through the passages and past the membrane surfaces. The second discharge zone is preferably located laterally outside the filtration cassette, whereby the bubbles in said second cleaning phase rise upwardly along the outside of the filtration cassette to cause upward lift of the wastewater around the cassette and, by circulation, downward flow of wastewater through the passages between the filter packs. The gas can be air or other gas chosen for removal of particular membrane deposits. The air can be pumped to the discharge zones from a common source, the MBR filtration cassette preferably having a valve and pipe system for delivering air to a selected one of the discharge zones. The rate of air discharge and bubble size to the first discharge zone can be selected for effective membrane scouring. The rate of air discharge and bubble size to the second discharge zone can be selected for effective air lift and resulting circulation of the wastewater around the outside of the filtration cassette and down through the passages of the filtration cassette.

The membrane filter packs can be plates of sandwich form having a pair of sheet form membranes flanking a central rectangular support member, the support member having compartments for receiving filtrate passing through the membranes, the compartments in fluid communication with an outlet manifold. Alternative filtration units can have, for example, tubular form.

The filtration chamber and its contents can be configured to function as a bioreactor chamber. Alternatively, in a sidestream MBR implementation, treated wastewater can be pumped from an upstream bioreactor chamber to the filtration chamber.

According to another aspect of the invention, there is provided MBR apparatus comprising a stack of generally vertically oriented membrane filter packs forming a filtration thereof, the cassette suspended in a filtration chamber for containing wastewater, an air delivery system operable in a first cleaning phase to deliver gas as bubbles to a first discharge zone at the bottom of the filtration cassette for scouring of membrane surfaces upon rising of the gas bubbles in a first direction through passages between the filter packs, and operable in a second cleaning phase to deliver air bubbles to a second discharge zone to cause airlift induced circulation of the wastewater around the outside of the filtration cassette and down through the passages in a direction different from the first direction.

Preferably, the second discharge zone is located laterally outside the stack to discharge bubbles, whereby the bubbles rise along the outside of the stack to cause upward lift of the wastewater around the stack and, by circulation, downward flow of wastewater through the passages between the filter plates. The apparatus can further comprise a pump for pumping air from a pipe and valve system operable in one phase to pump air to the first discharge zone but not to the second discharge zone and operable in a second phase to pump air to the second discharge zone but not to the first discharge zone.

The apparatus can include a first plenum connected to the pipe and valve system, the plenum preferably configured as a matrix of interconnected pipes, such as a row of parallel pipes, and having an array of holes for the release of the bubbles in the first cleaning phase. The apparatus can include a second plenum connected to the pipe and valve system, the plenum preferably configured as a perimeter pipe at the bottom of and extending around, the filtration cassette and having an array of holes for the release of the bubbles in the second cleaning phase. The apparatus can further include an adjustment means in the pump and valve system to select the rate of air discharge to the discharge zones. Preferably, the holes for the release of bubbles in both the matrix of interconnected pipe and the perimeter pipe open downwardly so that solid matter in the surrounding wastewater is less likely to block the holes.

The membrane filter packs can be of rectangular sandwich form having a pair of sheet-form membranes flanking a central support member, the support member having compartments for receiving filtrate passing through the membranes, the compartments in fluid communication with an outlet manifold. The filtration cassette can alternatively be configured as a stack of vertically extending tubular MBR filtration modules. The filtration chamber can be configured to function as a bioreactor chamber. Alternatively, the apparatus includes an upstream bioreactor chamber and pump means for pumping wastewater from the bioreactor chamber to the filtration chamber.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a perspective view of parts of a membrane bioreactor filtration cassette for use in a method and apparatus according to an embodiment of the invention.

FIG. 2 is a sectional view of apparatus according to an embodiment of the invention showing the apparatus in one operational cleaning phase.

FIG. 3 is a view corresponding to FIG. 2 showing the apparatus in a different operational cleaning phase.

FIG. 4 shows a sidestream MBR according to another embodiment of the invention.

### DETAILED DESCRIPTION OF THE INVENTION INCLUDING THE PRESENTLY PREFERRED EMBODIMENTS

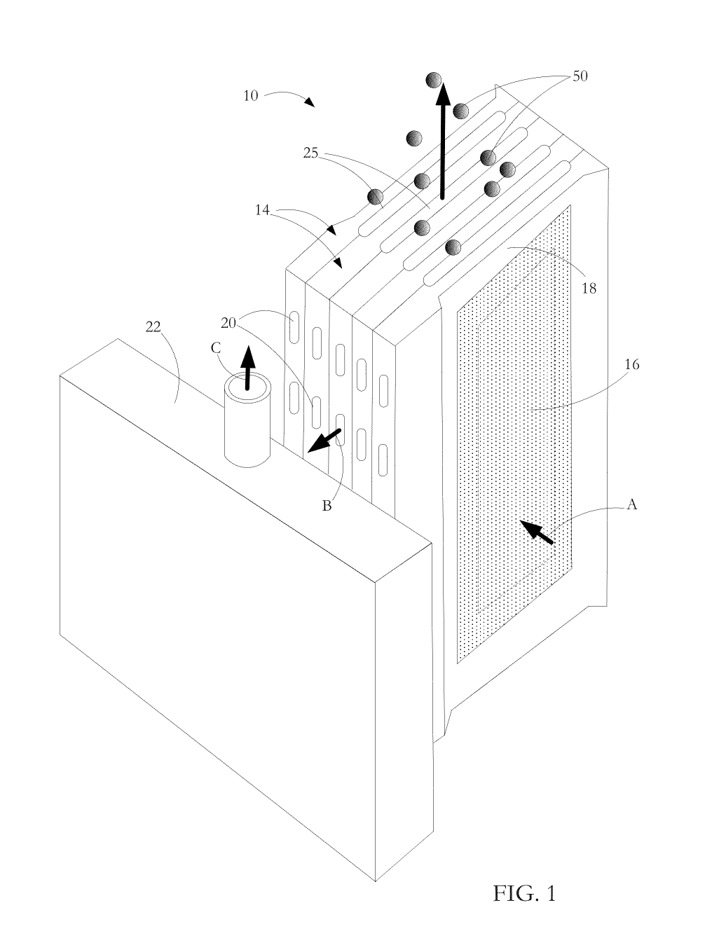

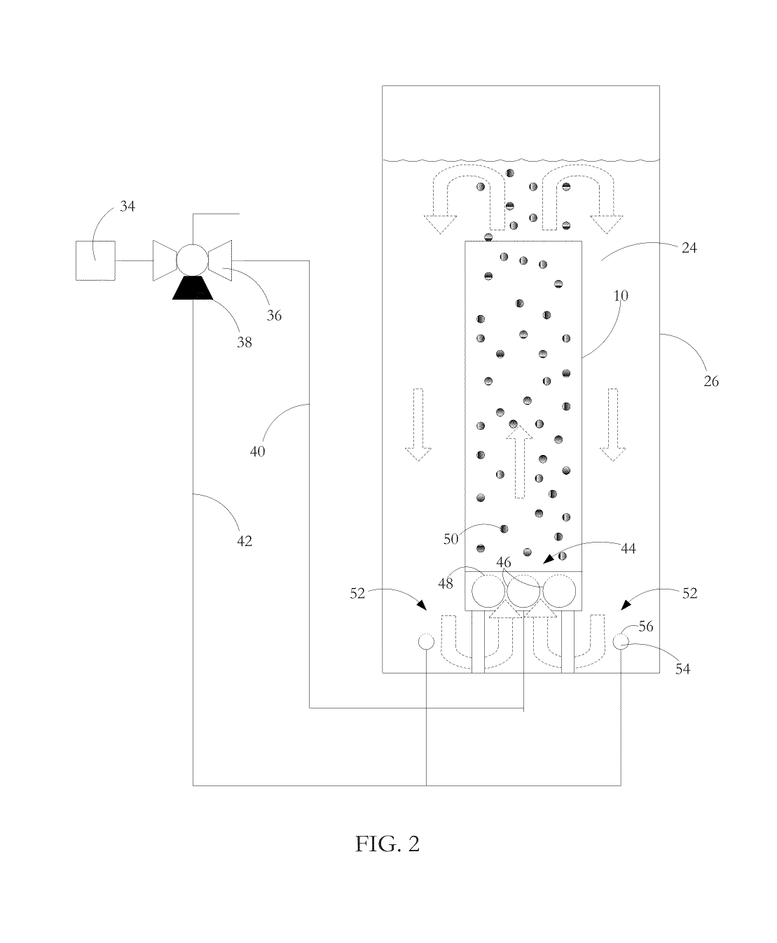

Referring to FIG. 1, there is shown a filtration cassette 10 for use in a membrane bioreactor apparatus. The cassette 10 is a stacked series of filter packs 14. Each pack 14 has a central plate 18 flanked by a pair of flat sheet-form ultrafine (UF) pore size membranes 16 which are welded to the plate 18. The plate 18 has a matrix of receiving chambers which are in fluid communication with vertical internal passages 25 and horizontal internal passages 20. The passages 25 vent to the interior of a filtration chamber as shown in FIG. 2. The passages 20 are in fluid communication with an outlet manifold 22 shown separated from the stacked filter plates to show filtrate flow (arrow B). The structure of the outlet manifold 22 also provides a supporting structure to fix the filtration packs 14 in their stacked configuration.

In use, as shown in FIG. 2, the filtration cassette 10 is suspended in wastewater 24 in the filtration chamber 26. Referring back to FIG. 1, a negative pressure is applied at the outlet manifold 22 to stimulate the migration of water from outside the filter plates 18, across the membranes 16 (arrow A), into vertically extending receiving chambers 25 and then through horizontally extending passages 20 (arrow B) to the outlet manifold 22. In the course of the passage of water though the membranes 16, particulate, bacterial and viral content in the wastewater is filtered out and remains in the wastewater concentrate 24 surrounding the filter plates 14. This collects as sludge in the filtration chamber 26. When the sludge reaches a predetermined concentration—typically 1%—it is pumped out of the filtration chamber and replaced by wastewater having a reduced solids concentration; for example, of the order of 1%. Cleaned water filtrate is removed (arrow C) at the outlet manifold 22 to be replaced by more wastewater to be treated which is piped into the filtration chamber 26. The individual membrane filter plates are shaped so that when configured as a stack, a vertical passage 25 exists between one membrane of one plate 18 and the facing membrane of the next adjacent plate 18. The passages 25 allow circulation of wastewater next to the membranes 16 to permit pressure induced filtration to occur. The passages 25 are also important for membrane cleaning as will be described presently.

In the illustrated embodiment, the filtration chamber 26, as well as housing the filtration cassette 10, also functions as a bioreactor chamber in which a chemically inert medium is maintained, the medium acting as a host for bacteria which feed on and break down organic material in the wastewater 24. Aerators may be used to inject oxygen into the wastewater to accelerate the bacteria feeding action. In addition, mixers may be used to agitate the reactor contents to increase the rate at which the bacteria and the organic materials come into contact and interact. Temperature and other conditions of the bioreactor chamber are carefully controlled so as to encourage and maintain the bacteria population as cleaned water is removed from the filtration cassette 10 and replacement wastewater is added to the chamber 26.

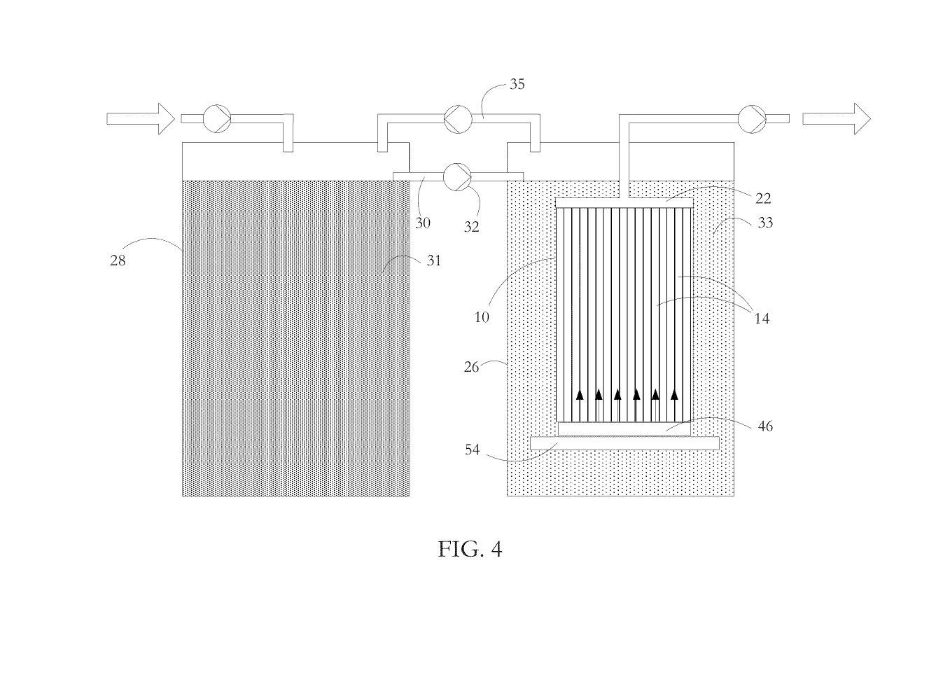

In an alternative embodiment of the invention as illustrated in FIG. 4, wastewater concentrate 33 within the filtration chamber 26 is relatively biologically inactive. Primary bioreaction in the wastewater 31 occurs in a preceding bioreaction chamber 28, with an output from the upstream bioreactor being driven through pipe 30 by pump 32 as less biologically active wastewater 33 to the filtration chamber 26. In operation, wastewater is pumped into the filtration chamber at a higher rate than filtrate is removed from the interior of the membrane filtration cassette. Excess water within the membrane filtration chamber is taken back through pipe 35 to the upstream bioreactor tank 28 to ensure the filtration chamber water does not become excessively thickened by the accumulation of sludge. In the sidestream embodiment, excess sludge is removed from the upstream bioreactor chamber, with the cycling back of excess wastewater from the filtration chamber ensuring that the sludge concentration is maintained at a low level in the filtration chamber. Other forms of suspended MBR applicable to the invention may use membranes filter plates of different form: for example, tubular packs.

As previously mentioned, a significant problem with MBR processes and equipment is the fouling of the filtration cassette 10. Fouling may occur at the membranes surfaces. Membrane fouling mechanisms vary and may include any or all of adsorption arising from chemical attraction or reaction between materials dissolved in the wastewater and the membrane material, membrane pore blockage if materials enter and lodge in the pores, the formation of a gelatinous film layer over pores, and the binding and growth of bacteria and other reaction products at the membranes 16. A particularly problematic blockage problem can occur if screens (not shown) used to pre-filter wastewater before it reaches the membrane filtration cassette are damaged or not properly installed. This can lead to the flow of fibrous material such as hair into the lower parts of the passages 25. The fibrous material may eventually build up into a dense mat at the bottom of one or more of the passages 25, with the mats then gathering grease to form a dense plug. Regardless of the cause, the presence of fibre mats, scale, biological fouling, etc., reduces the flux or throughput rate across the membranes for a given negative pressure applied at the outlet manifold 22. The presence of the fibre mats can block certain of the passages 25 altogether. If a membrane blockage occurs, it can be detected by virtue of decreasing throughput. Increasing filtration pressure beyond certain limits in most cases exacerbates the problem.

While filtration cassette blockage and membrane fouling can be corrected by frequent chemical cleaning, this presents problems including additional cost, downtime of the filtration cassette 10, and formation of hazardous byproducts. It is desirable therefore to minimize the potential for fouling during normal operation of the MBR filtration cassette. One effective method for inhibiting the growth of fouling at the membranes is air scouring or sparging.

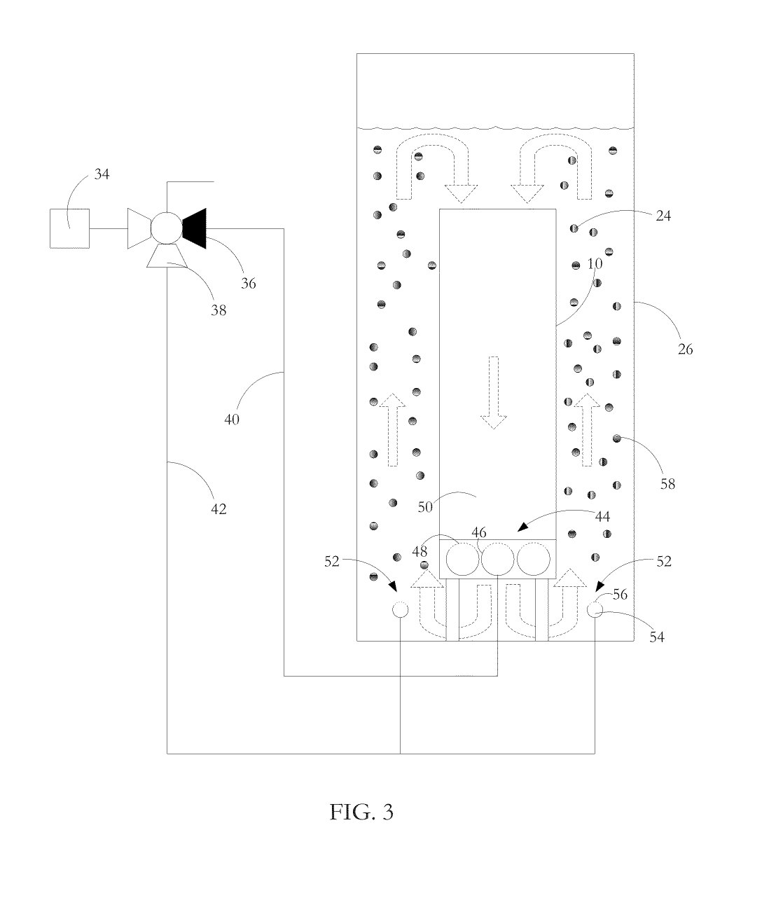

Referring to FIG. 3, there is shown MBR apparatus including a bioreactor chamber housing a filtration cassette 10 of the type illustrated in FIG. 2. The apparatus includes an air supply arrangement including an air supply 34, valves 36, 38 and pipes 40, 42.

In a first cleaning phase, valve 36 is opened to pass air from the source 34 through pipe 40 to a first discharge zone 44 under the filtration cassette 10. At the discharge zone 44, a matrix of pipes 46 having holes 48 is used to generate bubbles 50 during operation of the MBR filtration cassette. The matrix can be configured as a row of parallel pipes or any alternative configuration which ensures that a desired concentration of bubbles rises along each of the passages 25. As bubbles 50 rise up through the wastewater in the passages 25 they cause an air lift of the wastewater which consequently circulates up though the filtration cassette 10 and down around the outside of the cassette. The combination of the upward flow of wastewater past the membranes 16 and bubbles 50 driven by the turbulent flow against the membrane surfaces both inhibits the deposition of fouling such as scale and biofilm and to some extent strips from the membrane surface fouling material that does start to accumulate on the membranes. Inevitably though, as the filtration cassette 10 is operated over a period of time, mats of fibrous material and grease may build up at the bottom of the passages 25 where the wastewater enters the filtration cassette 10, so reducing the flow of wastewater into the filtration cassette. Plugging of one or more of the passages 25 increases the rate of air bubbling along those of the passages 25 that are not blocked which may be less than optimal in terms of effective scouring of scale and biofouling from the membranes. Also in the course of operational time, some scale and/or biofouling film will start to be deposited at sites on the membranes 16. This will normally be somewhat localized but once started, small deposits not removed by the air scouring will grow. This reduces the flux rate through the filtration cassette for a given negative pressure applied at the outlet manifold 22. A second cleaning phase is used which also uses the air supply 34 to mitigate the effects of fibre mat formation and membrane deposition.

In the second cleaning phase, the valve 36 is closed and the valve 38 is opened to pass air from the source 34 through pipe 42 to a second discharge zone 52 located near the bottom of the filtration cassette 10 and surrounding it. The second discharge zone 52 includes a rectangular pipe array 54 having holes 56 which are used to generate bubbles 58 in the second cleaning phase. During the second cleaning phase, the flow of wastewater across the membranes 16 is halted by suspending the application of negative pressure at the outlet manifold 22. Bubbles 58 from the pipe array 54 rise up around the outside of the filtration cassette 10 but not in the passages 25 between adjacent filter plates 14. The rising bubbles 58 have an air lift effect causing water in the chamber 26 to circulate in a torroidal fashion up around the filtration cassette 10 and then down into the filtration cassette 10 through the passages 25 between adjacent filter plates 14. The downward flow of wastewater causes fibrous mats that have accumulated at the bottom of the passages 25 to be flushed out of the bottom of the blocked passages 10 so opening up the lower ends of the passages 25.

The downward flow of water past the membrane surface also provides a supplementary water scouring effect. Because water flow is in a direction opposite to the water/bubble movement in the first cleaning phase, it develops a shear force that attacks deposited fouling particles and film from a different direction and may shear this off the membrane 16 if the deposit is more susceptible to downward scouring than upward scouring.

The bubble size and rate of release in the first cleaning phase is optimized for inhibiting expected deposition material, for the nature of the membranes 16 and for the flux rate across the membrane. It will be appreciated that the release of the air bubbles 50 can be tuned to the expected deposit. For example, the rate of flow of air into the matrix of pipes can be raised or lowered until optimal scouring is observed. Also, for example, larger or smaller bubbles can be generated using appropriately sized holes 48. In addition, bubbles 50 having a range of sizes can be developed. Further, the rate of generation of bubbles can be varied as by pulsing the bubbling phase. The tuning of bubble conditions may be set either from the viewpoint of the bubble dynamics of bubbles colliding with the membranes 16 or from the viewpoint of changing the speed of water airlift along the surfaces of the membranes 16 and both of these may be varied over time to subject any nascent deposit to varied scouring effects.

The bubble size and rate of release in the second cleaning phase is optimized for achieving a desired water pressure at the bottom of the passages 25 to dislodge accumulated fibrous mats and grease that has been caught by the fibres. The air flow into the pipe array and the nozzle frequency and size are chosen to develop a desired circulation flow and, with the flow, an associated pressure of wastewater driven into and down the passages 25. The rate and nature of wastewater flow down the passages 25 may also be altered or tuned to inhibit or remove, to some extent, material deposited on the membranes 16. Since there is no bubble/membrane collision in the second cleaning phase, the bubble generation is effected solely with the view of generating a level of airlift-induced circulation that drives wastewater the down past the membrane surfaces at a rate that presents sufficient pressure to flush out any normal build-up of fibre/grease mats.

While the filtration cassette 10 described previously consists of a series of flat filter packs 14 that are bonded together, it will be appreciated that other forms of filter membranes can be used provided that the membrane filter packs are generally vertically disposed and spaced to allow wastewater to flow upwardly or downwardly along the membrane surfaces and provided also that by selection of bubble release location, the wastewater can be caused circulate at one time to cause upward bubble/wastewater flow past the membrane surfaces and at another time to cause downward flow of wastewater past the membranes. Membrane modules may have any of a variety of shape and cross sectional areas suitable for use in a desired filtration application. In one alternative configuration, a series of tubular membranes are mounted vertically so that wastewater circulates in the interstices between tubes and filtrate accumulates in the tube interiors and is drawn off at an outlet manifold. In such an embodiment, in a first cleaning phase, bubbles and wastewater are caused to flow up the interstices by releasing bubbles at a discharge zone under the interstices. Subsequently, in the second cleaning phase, bubbles are released around the outside of the stack of tubes to promote airlift induced circulation of the wastewater so that it flows downwardly at the interstices.

The membranes may be made of any material (natural or synthetic) that provides desired filtration dynamics. The membrane packs may be mounted directly to the chamber walls or floor or may be mounted at support frame which may be removably attached to the chamber to facilitate removal of membrane packs for chemical cleaning, other maintenance, and replacement.

Whereas to maximize the airlift induced circulation of wastewater, the membrane filtration packs are ideally mounted in a vertical orientation, it will be appreciated that the two cleaning phases can be achieved even if the filtration packs are mounted off-vertical provided that the buoyancy of the bubbles in each cleaning phase can deliver the desired airlift induced circulation of wastewater.

It will be understood also that while in the preferred embodiment illustrated, air is used to scour in the first cleaning phase and to air lift in the second cleaning phase, a different gas can be used, for example, if anaerobic conditions are desired in the filtration chamber or if the gas has special properties in terms of removing or preventing the deposition of scaling or biofouling. Use of such a gas can be in combination with air or as a substitute for it and can be a constant or intermittent use.

It will be understood in addition that because filtration cassette blockage and fouling of membranes are relatively pervasive problems, many other techniques exist for inhibiting or removing fouling during normal operations of a filtration cassette. One example is backwashing, a process in which, by applying pressure on the filtrate side that is higher than the pressure within the wastewater, filtrate is flushed back through a membrane to the wastewater side to flush out the membrane pores from inside the pack. The two phase cleaning method and apparatus of the present invention can be used in conjunction with backwashing or with other compatible operational cleaning techniques.

Other variations and modifications will be apparent to those skilled in the art. The embodiments of the invention described and illustrated are not intended to be limiting. The principles of the invention contemplate many alternatives having advantages and properties evident in the exemplary embodiments.

1. A method of cleaning a membrane bioreactor (MBR) filtration cassette having a stack of generally vertically oriented membrane packs mounted in a filtration chamber containing wastewater comprising, in a first cleaning phase, supplying air to a first discharge zone to discharge gas bubbles into the wastewater at the bottom of the stack, whereby the gas bubbles rise through passages between the packs to scour surfaces of the membranes bounding the passages and to cause airlift induced circulation of the wastewater up through the passages, and, in a second cleaning phase, supplying gas to a second discharge zone to cause airlift induced circulation of the wastewater down through the passages.

2. A method as claimed in claim 1, the first discharge zone being under the filtration cassette, whereby the bubbles in said first cleaning phase rise upwardly past the membrane surfaces.

3. A method as claimed in claim 1, the second discharge zone being laterally outside the filtration cassette, whereby the bubbles in said second cleaning phase rise upwardly along the outside of the filtration cassette to cause upward lift of the wastewater around the stack and, by circulation, downward flow of wastewater through the passages between the packs.

4. A method as claimed in claim 1, wherein the gas is air.

5. A method as claimed in claim 1, comprising pumping air to the first and second discharge zones from a common source and operating a valve and pipe system to select one or other of the discharge zones.

6. A method as claimed in claim 1, the rate of air discharge and bubble size to the first discharge zone selected for effective membrane scouring.

7. A method as claimed in claim 1, the rate of air discharge and bubble size to the second discharge zone selected for effective air lift of the wastewater.

8. A method as claimed in claim 1, wherein the membrane filter packs are sandwich form plates, each having a pair of membranes flanking a central support member, the support member having compartments for receiving filtrate passing through the membranes, the compartments in fluid communication with an outlet manifold.

9. A method as claimed in claim 8, the filter plates being rectangular.

10. A method as claimed in claim 1, the chamber and its contents configured to function as a bioreactor chamber.

11. A method as claimed in claim 1, further comprising pumping wastewater from a bioreactor chamber to the filtration chamber.

12. Membrane bioreactor (MBR) filtration apparatus comprising a filtration cassette having a plurality of generally vertically oriented membrane filter packs forming a stack thereof, the stack suspended in a filtration chamber for containing wastewater, a gas delivery system operable in a first cleaning phase to deliver gas as bubbles to a first discharge zone at the bottom of the filtration cassette for scouring of membrane surfaces upon rising of the gas bubbles through passages between the packs and to cause circulation of the wastewater up through the passages, and operable in a second cleaning phase to deliver gas bubbles to a second discharge zone to cause airlift induced circulation of the wastewater down through the passages.

13. MBR filtration apparatus as claimed in claim 12, the second discharge zone being laterally outside the filtration cassette to discharge bubbles, whereby the bubbles rise along the outside of the stack to cause upward lift of the wastewater around the stack and, by circulation, downward flow of wastewater through the passages between the packs.

14. MBR filtration apparatus as claimed in claim 12, further comprising a pump for pumping air from a pipe and valve system operable in one phase to pump air to the first discharge zone but not to the second discharge zone and operable in a second phase to pump air to the second discharge zone but not to the first discharge zone.

15. MBR filtration apparatus as claimed in claim 14, further comprising a plenum connected to the pipe and valve system, the plenum having an array of holes for the release of the bubbles in the first cleaning phase.

16. MBR filtration apparatus as claimed in claim 15, the plenum configured as a row of interconnected pipes.

17. MBR filtration apparatus as claimed in claim 14, further comprising a plenum connected to the pipe and valve system, the plenum having an array of holes for the release of the bubbles in the second cleaning phase.

18. MBR filtration apparatus as claimed in claim 17, wherein the holes face downwardly.

19. MBR filtration apparatus as claimed in claim 17, the plenum configured as a perimeter pipe at the bottom of and extending around, the filtration cassette.

20. MBR filtration apparatus as claimed in claim 14, further comprising an adjustment means in the pump and valve system to select the rate of air discharge to the discharge zones.

21. MBR filtration apparatus as claimed in claim 12, wherein the membrane packs are of sandwich form having a pair of membranes flanking a central support member, the support member having compartments for receiving filtrate passing through the membranes, the compartments in fluid communication with an outlet manifold.

22. MBR filtration apparatus as claimed in claim 21, the filter plates being rectangular.

23. MBR filtration apparatus as claimed in claim 12, the filtration chamber configured to function as a bioreactor chamber.
